(19) United States
(12) Patent Application Publication
(10) Pub. No.: US 2004/0205812 A1
(43) Pub. Date: Oct. 14, 2004

(54) Method and apparatus for routing program data in a program viewing unit

(76) Inventor: Brant L. Candelore, Escondido, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 09/870,045

(22) Filed: May 29, 2001

Related U.S. Application Data
(60) Provisional application No. 60/213,291, filed on Jun. 22, 2000.

(51) Int. Cl. H04N 7/16; H04N 7/167

(52) U.S. Cl. 725/31; 725/25; 380/210

(57) ABSTRACT

A program viewing unit includes a demodulator unit that outputs program data with content in a scrambled format. The program viewing unit includes a conditional access unit that de-scrambles the content such that the content is in a clear format, a re-scrambler that re-scrambles the content for copy generation management purposes out to storage, and a de-scrambler that descrambles the re-scrambled content from storage. A switching unit is coupled to the demodulator unit, the conditional access unit, the re-scrambler, the descrambler, and a decoder. The switching unit simultaneously routes the program data with the content in the scrambled format and the program data with the content in the clear format in response to instructions from a central processing unit.

### CROSS-REFERENCE TO RELATED APPLICATION

This application claims the benefit of the filing date of the Provisional U.S. Patent Application entitled “A METHOD AND APPARATUS FOR ROUTING PROGRAM DATA IN A PROGRAM VIEWING UNIT”, application No. 60/213,291, filed Jun. 22, 2000.

### FIELD OF THE INVENTION

The present invention relates to program viewing units such as set top boxes used in entertainment systems. More specifically, the present invention relates to a method and apparatus for simultaneous viewing of program data with content in a clear format and recording of program data with content in a scrambled format.

### BACKGROUND OF THE INVENTION

Recording devices such as D-VHS video cassette recorders (VCRs) and hard disk based recording units are capable of producing high quality recordings and high quality copies of recordings without degradation. This poses a concern to the motion picture industry who wish to prevent the unauthorized copying of copyrighted material.

In response, there is a movement by the motion picture industry to require service providers, such as terrestrial broadcast, cable, and direct broadcast satellite (DBS) companies, to inject copy management protection commands into the system information of program data. The copy protection commands provide program viewing units with guidelines as to how program data may be recorded at the viewer's location. For example, the copy management protection commands may include a “copy never” command to indicate that specific program data with content in a clear format should never be copied, or a “copy free” command to indicate that specific program data with content in a clear format may be copied. The copying of program data with content in a scrambled format and later de-scrambling and viewing of the content may be permitted with the authorization of the service provider and coordination with the program viewing unit. The functionality of program viewing units such as set top boxes, thus, has extended beyond merely de-scrambling of content in program data from a service provider.

A drawback of current program viewing units is that they support either the viewing of program data with content in a clear format or the recording of program data with content in a scrambled format with the “copy never” copy management protection command. Current program viewing units do not allow both the viewing of clear content and the recording of scrambled content with the “copy never” copy management protection command.

Another drawback of current program viewing units is the complexity of the copy management protection schemes. For example, Digital Transmission Copy Protection (DTCP) used for delivering compressed content over, for example, IEEE1394 or USB requires elliptic curve public key cryptography, the use of certificates, and the processing of a revocation list. The schemes do not take into consideration content that may be playable only to a particular program viewing unit, or to program viewing units in a household. A content provider may allow copying of content if it could be restricted to the confines of a household.

### SUMMARY

A first program viewing unit is disclosed according to an embodiment of the present invention. The program viewing unit includes a demodulator unit that outputs program data with content in a scrambled format. The program viewing unit includes a conditional access unit that de-scrambles the content such that the content is in a clear format. A switching unit is coupled to the demodulator unit and the conditional access unit. The switching unit simultaneously routes the program data with the content in the scrambled format and the program data with the content in the clear format in response to instructions from a central processing unit.

A second program viewing unit is disclosed according to an embodiment of the present invention. The program viewing unit includes a central processing unit (CPU), a demodulator unit, a conditional access unit, a de-multiplexer unit, an encoding unit, and a switching unit. The switching unit is coupled to the CPU, the demodulator unit, the conditional access unit, the de-multiplexer unit, and the encoding unit. The switching unit is programmable by the CPU to route program data between the demodulator unit, the conditional access unit, the de-multiplexer unit, and the encoding unit.

A method for managing program data according to an embodiment of the present invention is disclosed. Program data is transmitted to a switch. The switch is selected to transmit the data to one of a de-multiplexing unit, conditional access unit, and an encoding unit.

### BRIEF DESCRIPTION OF THE DRAWINGS

The present invention is illustrated by way of example and not by way of limitation in the figures of the accompanying drawings, in which like references indicate similar elements and in which:

FIG. 1 is a block diagram of an entertainment system according to an embodiment of the present invention;

FIG. 2 is a block diagram of a first program viewing unit according to an embodiment of the present invention;

FIG. 3 is a block diagram of a first conditional access unit according to an embodiment of the present invention;

FIG. 4 is a block diagram of a second conditional access unit according to an embodiment of the present invention;

FIG. 5 is a block diagram of a second program viewing unit according to an embodiment of the present invention;

FIG. 6 is a block diagram of a third program viewing unit according to an embodiment of the present invention;

FIG. 7 is a table illustrating possible routing paths of the switch unit;

FIG. 8 is a flow chart illustrating a method of managing program data according to an embodiment of the present invention;

FIG. 9 is a flow chart illustrating a method of managing program data according to a second embodiment of the present invention; and

FIG. 10 is a block diagram of a third conditional access unit according to an embodiment of the present invention.

### DETAILED DESCRIPTION

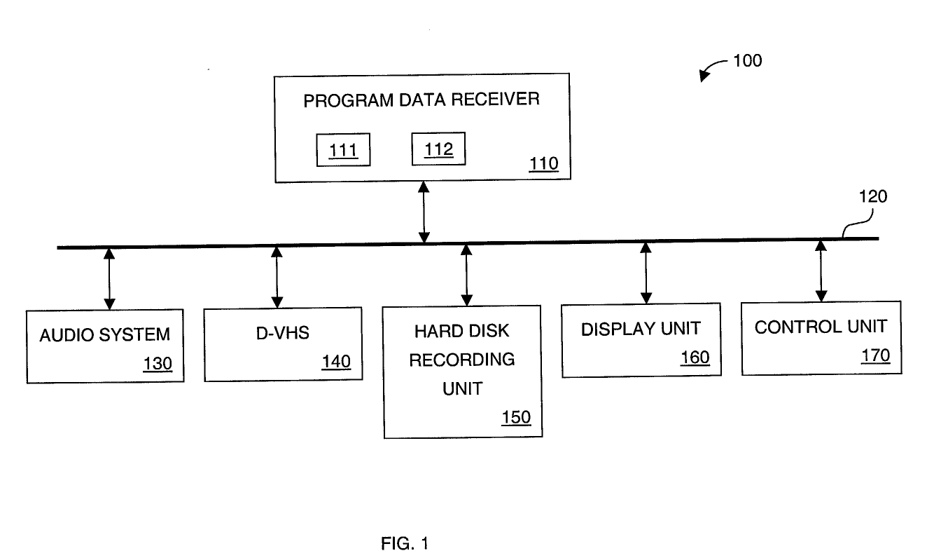

FIG. 1 is a block diagram of an entertainment system 100 according to an embodiment of the present invention. The entertainment system 100 includes a program data receiver 110. The program data receiver 110 receives program data from one or more service providers. A service provider may be, for example, a terrestrial broadcaster, a cable company, a DBS company, an Internet service provider (ISP), or other source. The program data receiver 110 includes a program viewing unit 111. The program viewing unit 111 operates to process the program data into a viewable format and to regulate access of the program data to other components on the entertainment system 100. The program data may include content, system information, entitlement management messages, entitlement control messages, and other data. Content may include audio and video data that may be in a scrambled or clear format. System information may include information on program names, time of broadcast, source, and a method of retrieval and decoding. The system information may also include copy management protection commands that provide program viewing units with guidelines as to how program data may be recorded. Entitlement management messages may be used to deliver privileges to the program viewing unit 111 such as rights and keys. An encrypted key, for example, may be a function of the rights granted. Entitlement control messages may be used to regulate access to a particular channel. According to an embodiment of the present invention, the program viewing unit 111 supports the simultaneous transmission of program data with content in a clear format and program data with content in a scrambled format.

The program data receiver 110 includes a viewing unit 112. The viewing unit 112 includes a decoding unit (not shown) and a display unit (not shown). The viewing unit 112 receives program data from the program viewing unit 111. The program data received is in a clear format that allows a program to be viewed. According to an embodiment of the present invention, the program data receiver 110 is a digital television set where the program viewing unit 111 is a built in set top box and the viewing unit 112 is a Motion Picture Experts Group (MPEG) decoder coupled to a display. It should be appreciated that the program data receiver 110 may be implemented with only the program viewing unit 111 as a stand alone set top box. The program data receiver 110 is coupled to a transmission medium 120. The transmission medium 120 operates to transmit data such as program data between the program data receiver 110 and other components in the entertainment system 100.

An audio system 130 may be coupled to the transmission medium 120. The audio system 130 may include speakers and an audio player/recorder such as a compact disk player, mini disk player, or other magneto-optical disk reader/writer that may be used to play or record audio data.

A D-VHS VCR 140 may be coupled to the transmission medium 120. The D-VHS VCR may be used to record analog or digital audio, video, and data transmissions. According to an embodiment of the entertainment system network 100, the D-VHS VCR 140 may be used to record program data on the transmission medium 120.

A hard disk recording unit 150 may be coupled to the transmission medium 120. The hard disk recording unit 150 may be a personal computer system, a stand alone hard disk recording unit, or other hard disk recording device capable of recording analog or digital, audio, video and data transmissions. According to an embodiment of the entertainment system network 100, the hard disk recording unit 150 may be used to record program data on the transmission medium.

A display unit 160 may be coupled to the transmission medium 120. The display unit 160 may be a high definition television that displays digital and analog signal transmissions, a conventional television set, or other display unit.

A control unit 170 may be coupled to the transmission medium 120. The control unit 170 may be used to coordinate the operation of the components on the entertainment system 100 and other electronic devices. It should be appreciated that FIG. 1 is an exemplary entertainment system 100 and that other components may be added or used in place of the components described.

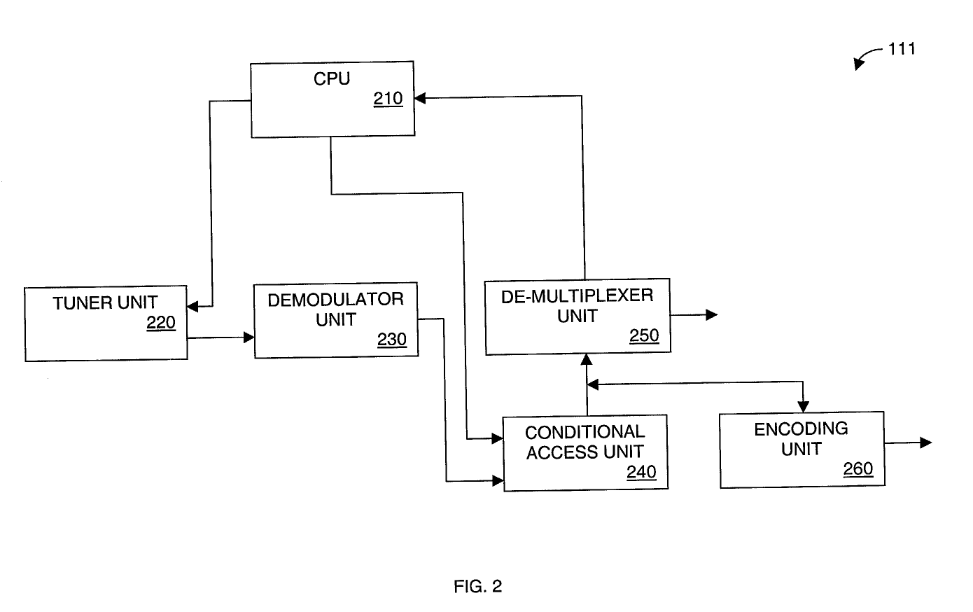

FIG. 2 is a block diagram of a first embodiment of the program viewing unit 111 according to the present invention. The program viewing unit 111 includes a central processing unit (CPU ) 210. The CPU 210 supports a graphical user interface that may be displayed on either the viewing unit 112 (shown in FIG. 1) or the display unit 160 (shown in FIG. 1). The graphical user interface allows a user to navigate through various program selections and to select a channel that is to be viewed. The CPU 210 determines a frequency in which a selected channel is broadcasted on and transmits this information to a tuner unit 220.

The tuner unit 220 is coupled to the CPU unit 210. The tuner unit 220 operates to select a frequency in the terrestrial, cable, or satellite broadcast in which to receive program data. The program data received from the selected frequency is in the form of signals which are amplified by the tuner unit 220.

A demodulator unit 230 is coupled to the tuner unit 230. The demodulator unit 230 receives the signals from the tuner unit 220 and converts the signals from an analog format to a digital format. The demodulator unit 230 may, for example, perform quadrature amplitude modulation for cable broadcast, quadrature phase shift keying for satellite broadcast, and vestigial side band modulation for terrestrial broadcast. The demodulator unit 230 also performs error correction on the program data received that may be introduced by the channel media.

A conditional access unit 240 is coupled to the CPU unit 210 and the demodulator unit 230. The conditional access unit 240 receives the program data from the demodulator unit 230. If the program data includes content in a scrambled format, the CPU unit 210 transmits information regarding a packet identifier where entitlement control messages may be found in the program data. The entitlement control messages regulate access to a particular channel and determines access rights needed to be held by a program viewing unit 111 in order to grant access. The entitlement control messages may also be used to deliver a key or deliver information on how to derive a key that may be used to de-scramble content in a scrambled format. If the program data includes scrambled content, the conditional access unit 240 de-scrambles the content using the key.

A de-multiplexer unit 250 is coupled to the conditional access unit 240. The de-multiplexer unit 250 receives the program data from the conditional access unit 240. The de-multiplexer unit 250 separates the system information in the program data from the content in the program data. According to an embodiment of the de-multiplexer unit 250, the de-multiplexer parses the program data for packet identifiers that are associated with system information, audio information, and video information. The de-multiplexer unit 250 transmits the system information to the CPU 210 and transmits the audio and video information to the viewing unit 112.

An encoding unit 260 is coupled to the conditional access unit 240. The encoding unit 260 receives the program data from the conditional access unit 240. The encoding unit 260 encodes program data with copy management protection commands that indicate that the program data is not “copy free.” The encoding unit 260 interfaces with the components on the transmission medium 120 (shown in FIG. 1) to determine which components are authorized to decode the encoded program data. The encoding unit 260 may transmit a key to the authorized components for decoding the encoded program data. According to an embodiment of the entertainment system 100, the encoding unit 260 may initiate an authentication process that identifies devices that are authorized to decode encoded program data. According to an embodiment of the present invention, the encoding unit 260 encodes program data transmitted on the transmission medium 120 using the IEEE 1394 encoding algorithm. It should be appreciated, however, that other encoding schemes may be implemented.

The CPU 210, tuner unit 220, demodulator unit 230, conditional access unit 240, de-multiplexer unit 250, and encoding unit 260 may be implemented using any known technique or circuitry. In one embodiment of the present invention, the CPU 210, tuner unit 220, demodulator unit 230, conditional access unit 240, de-multiplexer unit 250, and encoding unit 260 all reside on a single semiconductor substrate.

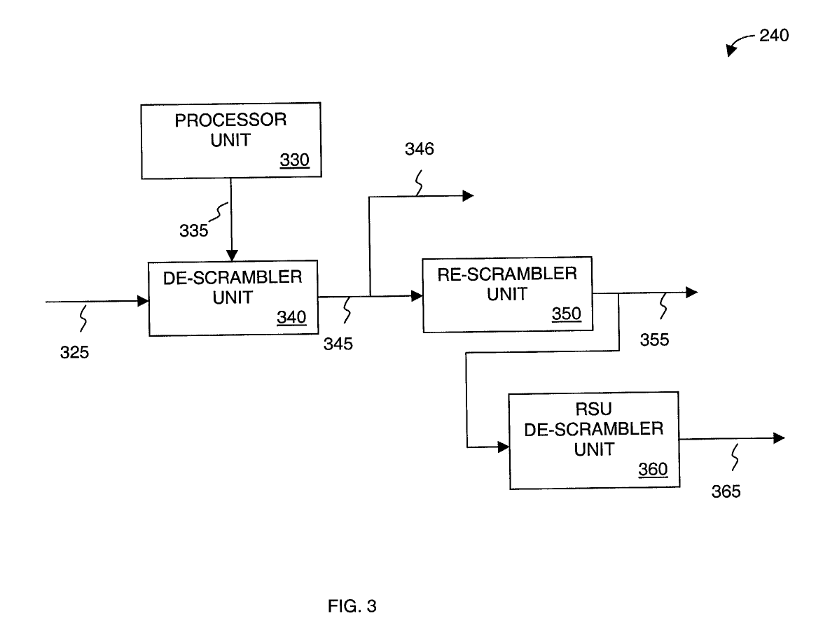

FIG. 3 is a block diagram of a first embodiment of the conditional access unit 240 according to the present invention. The conditional access unit 240 includes a processor unit 330. The processor unit 330 receives the program data from the demodulator unit 230 and information regarding a packet identifier where entitlement control messages may be found in the program data. For program data that includes content in a scrambled format, the processor unit 330 reads the entitlement control messages and derives a key for de-scrambling the content. The processor unit 330 transmits the program data and the key on line 335.

The conditional access unit 240 includes a de-scrambler unit 340. The de-scrambler unit 340 is coupled to the processor unit 330 via line 335. The processor unit may be a cryptographic processor with a security perimeter which prevents the observation or modification of secure processing, e.g. processing of access criteria and keys. The de-scrambler unit 340 receives the key and the program data off of line 335 and processes the program data. According to an embodiment of the present invention, the de-scrambler unit 340 de-scrambles or decrypts the content with the key. The content may come from, for example, the demodulator unit 230 and is received by the de-scrambler unit 340 on line 325. The de-scrambler unit 340 transmits the program data with the content in clear format on line 345.

The conditional access unit 240 includes a re-scrambler unit 350. The re-scrambler unit 350 is coupled to the de-scrambler unit 350 via line 345. The re-scrambler unit 350 receives the program data and processes the data. According to an embodiment of the present invention, the re-scrambler unit 350 re-scrambles the content in the program data with the key transmitted by the de-scrambler unit 340 via line 345. According to an alternate embodiment of the present invention, the re-scrambler unit 350 re-scrambles the content in the program data using a local key. A local key may be a key unique to the program viewing unit 111 or it may be downloaded to the program viewing unit 111. The program data with content that is re-scrambled is transmitted onto line 355 by the re-scrambler unit 350. The line 355 delivers the program data with content that is re-scrambled to the encoding unit 260 (shown in FIG. 2). The conditional access unit 240 may be implemented as a Application Specific Integrated Circuit (ASIC), however discrete implementations may be possible. In fact, the processor 330, may be implemented using the main CPU 210.

The conditional access unit 240 includes a re-scrambler de-scrambler unit denoted RSU de-scrambler unit 360. The RSU de-scrambler unit 360 is coupled to the re-scrambler unit 350 via line 355. The RSU de-scrambler unit 360 receives the program data and processes the data. According to an embodiment of the present invention, the RSU de-scrambler unit 360 de-scrambles the content in the program data with the key transmitted by the re-scrambler unit 350 via line 355. According to an alternate embodiment of the present invention, the RSU de-scrambler unit 360 de-scrambles the content in the program data using a local key. A local key may be a key unique to the program viewing unit 111. The program data with content that is de-scrambled is transmitted onto line 365 by the RSU de-scrambler unit 360. The line 365 delivers the program data with content that is de-scrambled to the encoding unit 260 (shown in FIG. 2).

The program data may also be scrambled using a method where keys and control words are used. In this method, the content in the program data may be scrambled using control words that may change periodically over time. The control words are injected in the program data and scrambled using a key. In order to de-scramble the content in the program data, the control access unit 240 must first derive the key and then use the key to de-scramble the control words. The control words are then applied to de-scramble the content. It should be appreciated that the re-scrambler unit 350 may process the program data by scrambling the content with the original control words and scramble the control words with the original key, scramble the program data with local control words and keys that are unique to the program viewing unit 111, scramble the content with a single local key without using control words, or by using other encoding schemes. It should be appreciated that the processor unit 330, the de-scrambler unit 340, and the re-scrambler unit 350 may be implemented using any known circuitry or technique.

The conditional access unit 240 includes a line 346 coupled to line 345 that transmits program data with content in a clear format to either the de-multiplexer unit 250 (shown in FIG. 2) or to the encoding unit 260 without passing the program data to the re-scrambler unit 350. The line 346 and the line 355 provides two streams of program data. Line 346 carries a stream having program data with content in a clear format and line 355 carries a stream having program data with content that has been re-scrambled. By providing a stream of program data with content that is in a clear format and a stream of program data with content that has been re-scrambled, the conditional access unit 240 allows simultaneous viewing of program data with content in a clear format (de-scrambled program data) and recording of program data with content in a scrambled format (scrambled program data).

It is to be further appreciated that in one embodiment the program data with content that is re-scrambled is transmitted onto line 355 by the re-scrambler unit 350 which is then received by the encoding unit 260 (shown in FIG. 2) and that the encoding unit 260 interfaces with the components on the transmission medium 120 (shown in FIG. 1) to determine which components are authorized to decode the encoded program data. The encoding unit 260 may transmit a key to the authorized components for decoding the encoded program data. Thus, the authorized component may have a decoder. In an alternative embodiment, the decoding for the authorized component may be located within the conditional access unit 240. Thus, for example, the decoding of content that is re-scrambled by the re-scrambler unit 350 may be performed by the de-scrambler unit 340. In such an embodiment, keys needed for de-scrambling may be local, or received from a remote unit, for example, components authorized to decode the encoded program data.

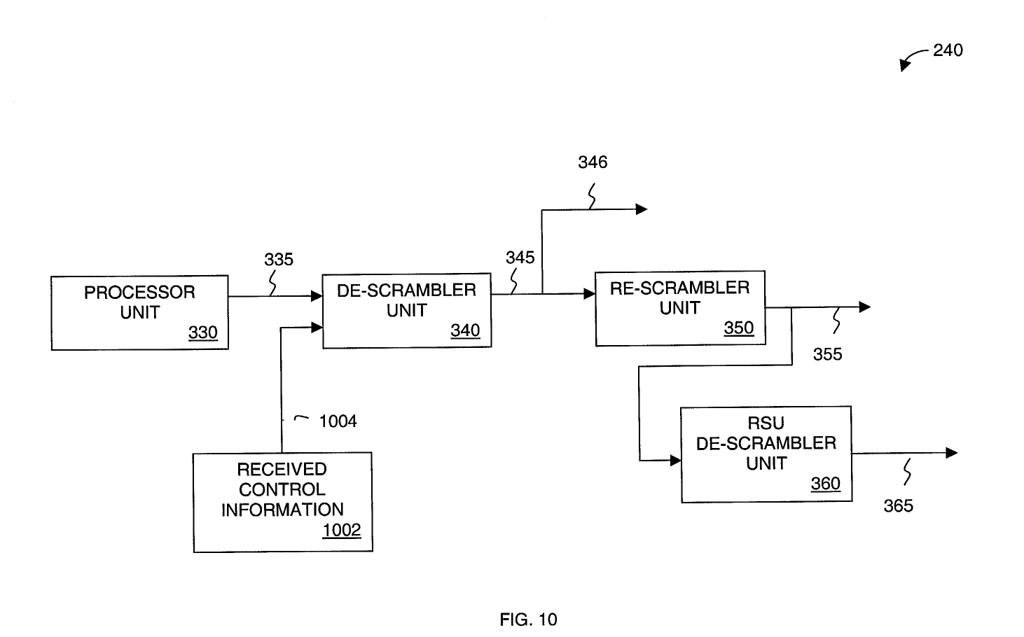

FIG. 10 is a block diagram of a third conditional access unit according to an embodiment of the present invention. FIG. 10 is similar to FIG. 3 however two additional control mechanisms are present. Received control information 1002 via line 1004 controls the de-scrambler unit 340. Additionally, re-scrambler unit 350 is controlled via line 1012 from copy generation management 1010. For example, received control information 1002 may be information concerning a user, viewer, etc. For example, ordering information, billing information, payment information, credit information, sponsor information, preview information, viewer information, parental control information, etc. may be used to control the de-scrambler unit 340. Thus, for example, a parent may set a credit amount for a specific viewer and perhaps also a parental viewing setting such as general audiences. Likewise the copy generation management 1010 may control the re-scrambler unit 350 based on information received from, for example, the service provider, the content provider, etc.

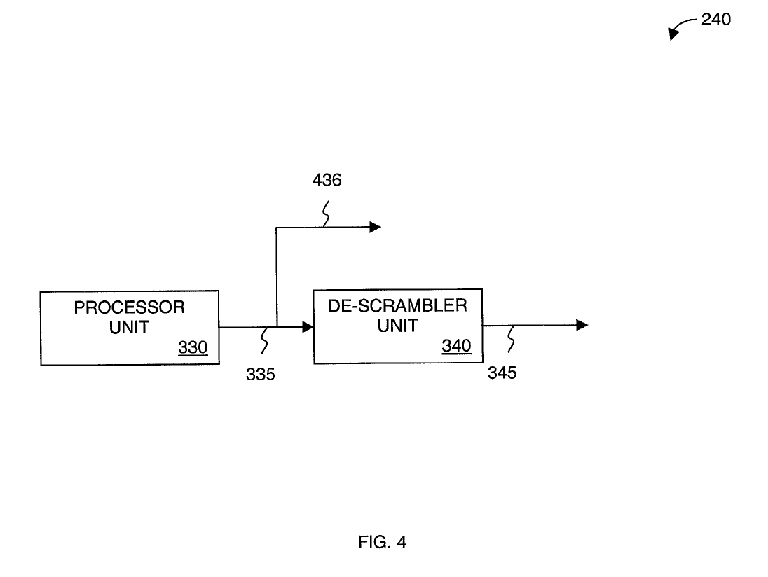

FIG. 4 is a block diagram of a second embodiment of the conditional access unit 240 according to the present invention. The conditional access unit 240 includes a processor unit 330 similar to that described in FIG. 3. The conditional access unit 240 includes a line 335 that is similar to that described in FIG. 3. The line 335 is used to transmit program data that may include content in a scrambled format to the de-scrambling unit 340. The conditional access 240 unit also includes a de-scrambler unit 340 similar to that described in FIG. 3. The de-scrambler unit 340 outputs program data with content in a clear format to either the de-multiplexer unit 250 (shown in FIG. 2) or to the encoding unit 260 (shown in FIG. 2) via line 345. The conditional access unit 240 further includes a line 436 coupled to the line 335. The line 436 transmits program data that may include content in a scrambled format to the encoding unit 260, by-passing the de-scrambling unit 340.

The line 436 and the line 345 provide two streams of program data. Line 345 carries a stream having program data with content in a clear format and line 436 carries a stream having program data with content that is scrambled. By providing a stream of program data with content that is in a clear format and a stream of program data with content that has been scrambled, the conditional access unit 240 allows simultaneous viewing of de-scrambled program data and recording of scrambled program data.

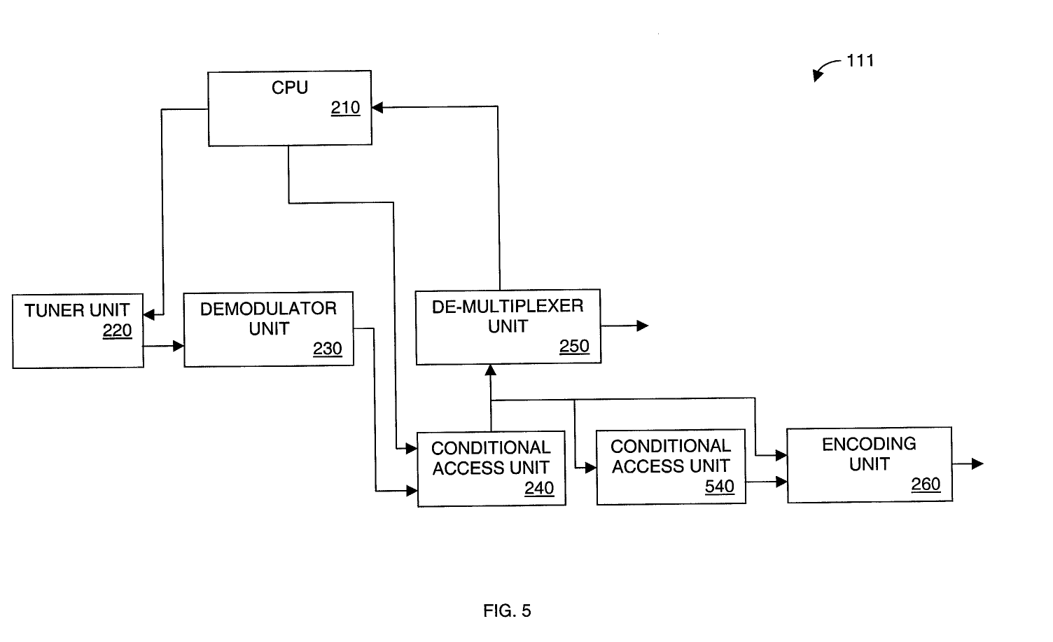

FIG. 5 is a block diagram of a second embodiment of the program viewing unit 111 according to the present invention. The program viewing unit 1111 includes a CPU 210, a tuner 220, a demodulating unit 230, a first conditional access unit 240, a de-multiplexing unit 250, and an encoding unit 260. The CPU 210, tuner 220, demodulating unit 230, conditional access unit 240, first conditional access unit 240, demultiplexing unit 250, and encoding unit 260 operate similarly as described in FIG. 2. The program viewing unit 111 further includes a second conditional access unit 540. The second conditional access unit 540 may be built into the program viewing unit 111. Alternatively, the second conditional access unit 540 may be an add-on feature to the program viewing unit 111. For example, the program viewing unit 111 may have a Personal Computer Memory Card International Association (PCMCIA) slot that receives a PCMCIA card with a second conditional access unit 540.

The second conditional access unit 540 is coupled to the CPU 210, the first conditional access unit 240, and the encoding unit 260. The second conditional access unit 540 receives program data with content in a clear format from the first conditional access unit 540 and processes the data in response to instructions from the CPU 210. According to an embodiment of the present invention, the second conditional access unit 540 re-scrambles the content in the program data with a key transmitted by the first conditional access unit 240. According to an alternate embodiment of the present invention, the second conditional access unit 540 re-scrambles the content in the program data using a local key. If the content was originally scrambled using control words and keys, the second conditional access unit 540 may process the program data by scrambling the content with the original control words and scramble the control words with the local key that is unique to the program viewing unit 111, scramble the content with a single local key without using control words, or use other encoding schemes. The second conditional access unit 540 transmits the re-scrambled program data to the encoding unit 260. In some implementations, the encoding unit 260 may not be required if the content is scrambled. The use of a local or downloaded re-scrambling key may eliminate the requirement for complex encoding schemes such as Digital Transmission Copy Protection (DTCP). In this embodiment of the program viewing unit 111, the first conditional access unit 240 need not include a re-scrambling unit 350 (shown in FIG. 3) nor an additional line 436 (shown in FIG. 4) for routing program data with content in a scrambled format.

The second conditional access unit 540 allows a stream of program data with content that has been re-scrambled to be routed to the encoding unit 250 while program data with content that is in a clear format is transmitted to either the encoding unit 250 or to the de-multiplexer unit 250. By facilitating the transport of a stream of program data with content that is in a clear format and a stream of program data with content that has been re-scrambled, the program viewing unit 111 allows simultaneous viewing of de-scrambled program data and recording of scrambled program data.

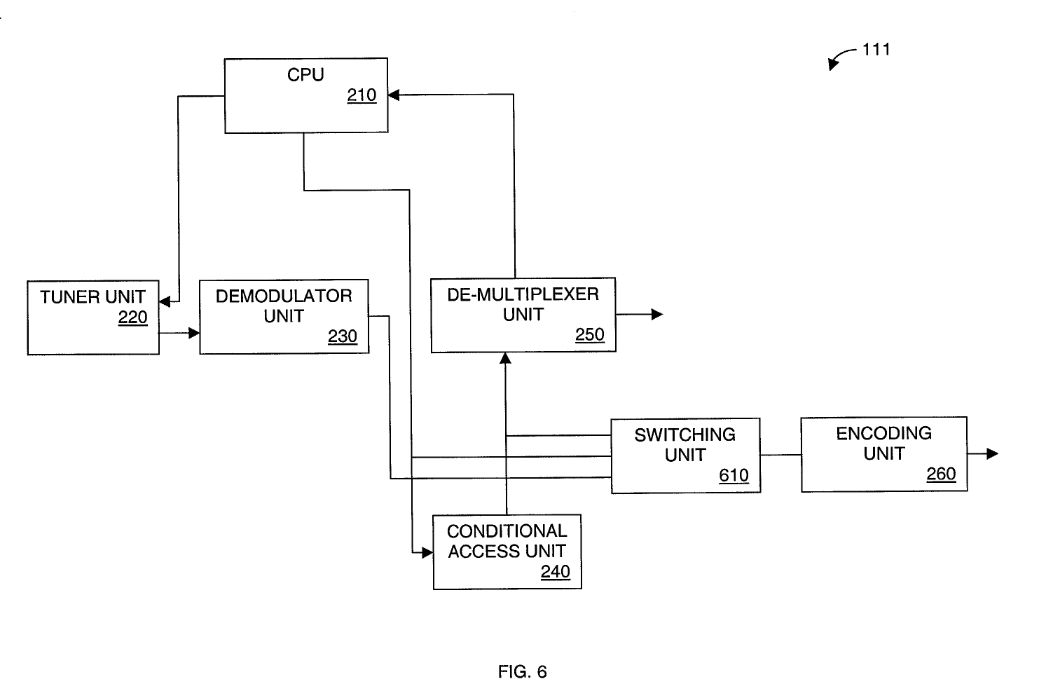

FIG. 6 is a block diagram of a third embodiment of the program viewing unit 111 according to the present invention. The program viewing unit 111 includes a CPU 210, a tuner 220, a demodulating unit 230, a conditional access unit 240, a de-multiplexing unit 250, and an encoding unit 260. The CPU 210, tuner 220, demodulating unit 230, conditional access unit 240, demultiplexing unit 250, and encoding unit 260 operate similarly as described in FIG. 2. The program viewing unit 111 further includes a switching unit 610. The switching unit 610 is coupled to the CPU 210, the demodulating unit 230, the conditional access unit 240, the de-multiplexing unit 250, and the encoding unit 260. The switching unit 610 operates as a router that may direct program data to the conditional access unit 240, the de-multiplexer, or the encoding unit 260 with the direction of the CPU 210. For example, the switching unit 610 may direct program data with content in a scrambled format received from the demodulator unit 230 to the encoding unit 260 while simultaneously directing program data with content in a clear format received from the conditional access unit 240 to the encoding unit 260 or to the de-multiplexer unit 250. In this embodiment of the program viewing unit 111, the conditional access unit 240 need only perform the functionality of de-scrambling program data with content in a scrambled format. The conditional access unit 240 need not include a re-scrambling unit 350 (shown in FIG. 3) nor an additional line 436 (shown in FIG. 4) for routing program data with content in a scrambled format.

The switching unit 610 allows a stream of program data with content that is scrambled to be routed to the encoding unit 250 while program data with content that is in a clear format is transmitted to either the encoding unit 250 or to the de-multiplexer unit 250. By facilitating the transport of a stream of program data with content that is in a clear format and a stream of program data with content that has been scrambled, the program viewing unit 111 allows simultaneous viewing of de-scrambled program data and recording of scrambled program data. According to an embodiment of the present invention, the switch unit 610 may be implemented with a multiplexer.

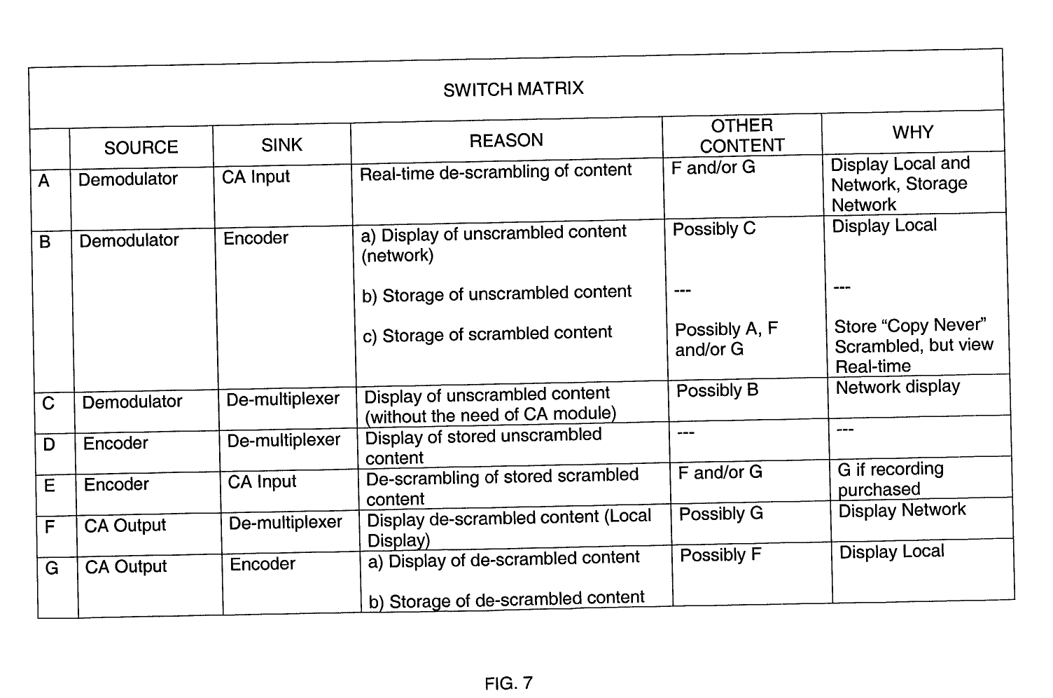

The switching unit 610 may also be directed by the CPU 210 to perform other routing operations as shown on the table illustrated in FIG. 7. The switching unit 610 may provide a connection that routes program data from the demodulator unit 230 to the conditional access unit 240 to facilitate real-time de-scrambling of program data with content in a scrambled format. In this mode, the switching unit 610 may also provide a connection from the output of the conditional access unit 240 to the de-multiplexer 250 to facilitate the display of the program data locally on the viewing unit 112 (shown in FIG. 1). The switching unit 610 may also provide a connection from the output of the conditional access unit 240 to the encoding unit 260 to facilitate the display of de-scrambled program data on the display unit 160 (shown in FIG. 1) and/or the recording of the de-scrambled program data on either the D-VHS VCR 140 (shown in FIG. 1) or the hard disk recording unit 150 (shown in FIG. 1).

The switching unit 610 may provide a connection that routes program data from the demodulator unit 230 to the encoding unit 260 to facilitate displaying of unscrambled program data on the display unit 160, or the recording of scrambled or unscrambled program data by either the D-VHS VCR 140 or the hard disk recording unit 150. In this mode, the switching unit 610 may provide a connection from the demodulator unit 230 to the de-multiplexer unit 250 to facilitate the display of program data on a local display in the viewing unit 112.

The switching unit 610 may provide a connection that routes program data from the demodulator unit 230 to the de-multiplexer unit 250 to facilitate the display of unscrambled program on a display in the viewing unit 112. In this mode, the switching unit 610 may also provide a connection from the demodulator unit 230 to the encoding unit 260 to facilitate the display of program data on the display unit 160.

The switching unit 610 may provide a connection that routes program data from the encoding unit 260 to the de-multiplexer unit 250 to facilitate the display of stored unscrambled program data.

The switching unit 610 may provide a connection that routes program data from the encoding unit 260 to the input of the conditional access unit 240 to facilitate the de-scrambling of stored program data with content in a scrambled format. In this mode, the switching unit 610 may also provide a connection from the output of the conditional access unit 240 to the de-multiplexer unit 250 to allow the display of the program data on the display unit 160.

The switching unit 610 may provide a connection that routes program data from the conditional access unit 240 to the de-multiplexer unit to facilitate the display of de-scrambled program data onto a local display on the viewing unit 112. In this mode, the switching unit 610 may also provide a connection from the output of the conditional access unit 240 to the encoding unit 260 to allow the display of the program data on the display unit 160.

The switching unit 610 may provide a connection that routes program data from the output of the conditional access unit 240 to the encoding unit 260 to facilitate the display of de-scrambled program data on the display unit 160 or to store de-scrambled program data on the D-VHS VCR 140 or the hard disk recording unit 150. In this mode, the switching unit 610 may also provide a connection from the output of the conditional access unit 240 to the de-multiplexer 250 to facilitate the display of the program data on the display of the viewing unit 112.

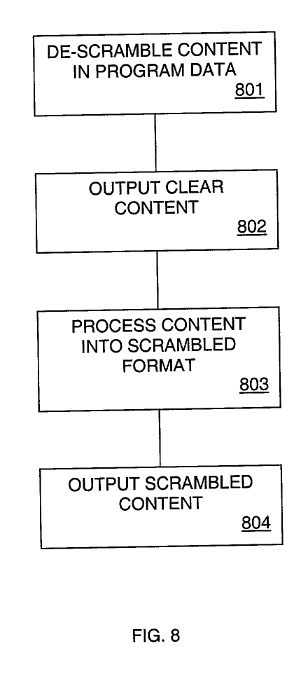

FIG. 8 is a flow chart illustrating a method of managing program data according to an embodiment of the present invention. At step 801, content in the program data is de-scrambled such that the content is in a clear format. According to an embodiment of the present invention, de-scrambling the content in the program data includes deriving a key from entitlement control messages in the program data, decoding a control word with the key, and decoding the content with the control word.

At step 802, the program data with the content in the clear format is output onto a first line.

At step 803, the program data with the content in the clear format is processed such that the content in the clear format is in a scrambled format. The content in the clear format may be processed by scrambling the content in the clear format with an original key or scrambling the content in the clear format with an original control word and further scrambling the control word with an original key. Alternatively, processing the program data with the content in the clear format may include scrambling the content in the clear format with a local key.

At step 804, the program data with the content in the scrambled format is output onto a second line.

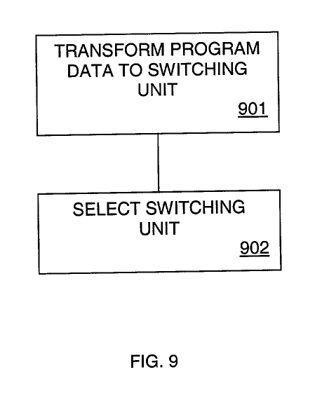

FIG. 9 is a flow chart illustrating a method of managing program data according to a second embodiment of the present invention. At step 901, the program data is transmitted to a switching unit. The program data may include content that is in a clear format or content that is in a scrambled format. The program data may be transmitted to the switching unit from a demodulator unit, a conditional access unit, or an encoding unit.

At step 902, the switching unit is selected to transmit the data to one of a de-multiplexing unit, conditional access unit, and an encoding unit. The switching unit may be selected by a CPU. The switching unit may be selected to transmit the program data from the demodulator unit to the conditional access unit in order to facilitate real-time de-scrambling of program data. The switching unit may be selected to transmit the program data from the demodulator to the encoding unit in order to facilitate displaying of unscrambled program data on a display unit on the network, or storing of scrambled or unscrambled program data on a recording device on the network. The switching unit may be selected to transmit the program data from the demodulator unit to the de-multiplexer unit in order to facilitate the display of unscrambled program data. The switching unit maybe selected to transmit the program data from the encoding unit to the de-multiplexer in order to facilitate the display of stored unscrambled program data. The switching unit may be selected to transmit program data from the encoding unit to the input of the conditional access unit in order to facilitate the de-scrambling of stored scrambled program data. The switching unit may be selected to transmit program data from the output of the conditional access unit to the de-multiplexer unit in order to facilitate the display of de-scrambled program data on a local display. The switching unit may be selected to transmit program data from the output of the conditional access unit to the encoding unit in order to facilitate the displaying of de-scrambled program data on a display unit on the network or the recording of de-scrambled program data on a recording device on the network.

In the foregoing description, the invention is described with reference to specific exemplary embodiments thereof. It will, however, be evident that various modifications and changes may be made thereto without departing from the broader spirit and scope of the present invention as set forth in the appended claims. The specification and drawings are accordingly to be regarded in an illustrative rather than in a restrictive sense.

What is claimed is:

1. A program viewing unit, comprising:
a source of content in scrambled format;
a conditional access unit that de-scrambles the content such that the content is in a clear format; and
a switching unit, coupled to the demodulator unit and the conditional access unit, that routes the program data with the content in the scrambled format and the program data with the content in the clear format in response to instructions from a central processing unit.

2. The program viewing unit of claim 1, wherein the source is selected from the group consisting of demodulator, re-scrambler, conditional access unit, and package media-reader.

3. The program viewing unit of claim 1, wherein the switching unit comprises a multiplexer.

4. The program viewing unit of claim 1, wherein the switching unit routes the program data with the content in the scrambled format to the conditional access unit.

5. The program viewing unit of claim 1, further comprising an encoding unit, coupled to the switching unit, that encodes the program data with the content in the clear format before transmitting the program data with the content in the clear format to a display unit.

6. The program viewing unit of claim 1, further comprising an encoding unit, coupled to the switching unit, that transmits the program data with the content in the scrambled format to a recording device.

7. The program viewing unit of claim 1, further comprising a de-multiplexing unit, coupled to the switching unit, that transmits the program data with the content in the clear format to a viewing unit.

8. The program viewing unit of claim 7, wherein the program data in clear a format is first encoded prior to transmittal to the viewing unit.

9. The program viewing unit of claim 8, wherein the encoding is selected from the group consisting of Digital Transmission Copy Protection (DTCP), watermark, and High Bandwidth Digital Copy Protection (HDCP).

10. A program viewing unit, comprising:
a demodulator unit that outputs program data with content in a first scrambled format;
a de-scrambler that de-scrambles the program data with content in the first scrambled format into content in a first clear format; and
a re-scrambler that re-scrambles the content in the first clear format into content in a second scrambled format.

11. The program viewing unit of claim 10, wherein the re-scrambler uses a local key.

12. The program viewing unit of claim 11, wherein the local key is generated in part by using the copy protection status of the content.

13. The program viewing unit of claim 11, wherein the local key is generated in part by using keys that are downloaded from a service operator.

14. The program viewing unit of claim 13, wherein the service operator is selected from the group consisting of cable operator, telephone operator, Internet operator, broadcaster, and Direct Broadcast Satellite (DBS).

15. The program viewing unit of claim 11, wherein the local key is generated in part by using embedded keys from the re-scrambler.

16. The program viewing unit of claim 10, wherein the de-scrambler is controlled by a conditional access mechanism coupled to receive information, wherein the information is selected from the group consisting of ordering information, billing information, payment information, credit information, sponsor information, preview information, viewer information, and parental control information.

17. The program viewing unit of claim 10, wherein the re-scrambler is coupled to receive information on copy generation management.

18. The program viewing unit of claim 10, further comprising a second descrambler coupled to receive content in the second scrambled format and output content in a second clear format.

19. The program viewing unit of claim 18, further comprising a switching unit coupled to receive an input and communicate the input to a display unit, wherein the input is the content in the first clear format or the content in the second clear format.

20. A program viewing unit, comprising:
a central processing unit (CPU);
a demodulator unit;
a conditional access unit;
a de-multiplexer unit;
an encoding unit; and
a switching unit, coupled to the CPU, the demodulator unit, the conditional access unit, the de-multiplexer unit, and the encoding unit that is programmable by the CPU to route program data between the demodulator unit, the conditional access unit, the de-multiplexer unit, and the encoding unit.

21. The program viewing unit of claim 20, wherein the program viewing unit further comprises a re-scrambler and a descrambler which is coupled to the switching unit.

22. The program viewing unit of claim 20, wherein the conditional access unit comprises:
a processor unit; and
a de-scrambler unit.

23. A method for managing program data, comprising:
transmitting the program data to a switch; and
selecting the switch to transmit the data to one of a de-multiplexing unit, a conditional access unit, and an encoding unit.

24. The method of claim 23 wherein the switch can additionally transmit data to one of a re-scrambler and a descrambler.

25. The method of claim 23, wherein the selecting is performed by a central processing unit.

26. The method of claim 23, wherein the program data is transmitted from a demodulating unit.

27. An apparatus for managing program data, comprising:
means for transmitting the program data to a switch; and
means for selecting the switch to transmit the data to one of a de-multiplexing unit, a conditional access unit, and an encoding unit.

28. A machine-readable medium having stored thereon instructions, which when executed by a processor, causes said processor to perform the following:
transmit program data to a switch; and
select the switch to transmit the program data to one of a de-multiplexing unit, a conditional access unit, and an encoding unit.
